(19) United States
(12) Patent Application Publication
(10) Pub. No.: US 2022/0339557 A1
(43) Pub. Date: Oct. 27, 2022

(54) A SEPARATION APPARATUS WITH INSERT

(71) Applicant: Stauper Offshore AS, Sandefjord (NO)

(72) Inventor: Eivind SINGDAHLSEN, Sandefjord (NO)

(73) Assignee: Stauper Offshore AS, Sandefjord (NO)

(21) Appl. No.: 17/640,747

(22) PCT Filed: Sep. 3, 2020
(86) PCT No.: PCT/EP2020/074640

§ 371 Date: Mar. 4, 2022

(30) Foreign Application Priority Data
Sep. 6, 2019 (NO) 20191079

(51) Int. Cl. B01D 17/02; B01D 17/12; B01D 19/00; C02F 1/40; C02F 1/38; B04C 5/04; B04C 5/103; B04C 3/06; E21B 43/34

(52) U.S. Cl. CPC B01D 17/0217; B01D 17/0208; B01D 17/12; B01D 19/0057; C02F 1/40; C02F 1/38; B04C 5/04; B04C 5/103; B04C 3/06; E21B 43/34; C02F 2101/32

(57) ABSTRACT

A separation apparatus for separating hydrocarbons and water, comprising a vessel (1) and an insert (5, 6) within said vessel (1). The has a bottom (7), a conical wall (8) and a quiecer (10) at the top of the wall (8), which enclose a separation chamber (11). The insert (5, 6) has an inlet pipe (12) for a mixture of water and hydrocarbons and a spreader arrangement (13, 14) arranged inside the separation chamber (11), which directs an inflow of fluids in a tangential direction, setting the fluids into a tangential laminar swirl. The vessel (1) has at least one manhole (3, 4), and said insert bottom (7), wall (8) and quiecer (10) are assembled by a plurality of generally wedge shaped segments (7a-l, 8a-l, 10a-l) having a size that allows the segments (7a-l, 8a-l, 10a-l) to be brought through the manhole (3, 4).

### TECHNICAL FIELD

The present invention concerns an apparatus for separating hydrocarbons and water, in particular of the kind using a process gas for lifting oil out of the water phase from produced water associated with oil and gas production or extraction of oil from oil contaminated water. The invention is in particular directed to an insert that can be mounted inside an existing separator vessel, such as a gravity separator vessel.

### BACKGROUND ART

Separating hydrocarbons, i.e. oil and/or gas, and water is required in several applications. One typical example is separating oil from bilge water aboard a ship. Another example is separating oil and/or natural gas from well fluid produced at an on- or offshore oil or gas field. In both examples, the input fluid typically has a high content of water. Further, the rate of input fluid may be large, and the space available for a separator tank aboard a ship or in an offshore platform may be limited and costly.

Hydro-cyclones and other fast liquid-liquid separators are known in the art and are not further discussed herein. The invention concerns a separator for an input process fluid containing mainly oil-contaminated water for example from hydro-cyclones but will usually also contain gas.

Separators of the kind described herein use a process gas, e.g. air, N2 or CO2, to form bubbles. Oil in the input fluid attaches to the bubbles, and rises to the surface, whereas the water sinks. Gaseous hydrocarbons also form bubbles and are removed from the top of the separator tank together with process gas and oil. As the amount of dissolved gas in a liquid is proportional to the pressure above the liquid, the pressure in the output liquid is typically equal to ambient pressure to ensure that the gas is released within the separator tank. Any particles in the process fluid will also be removed in the separator.

WO 02/41965 discloses a separator tank wherein a vortex is set up within a vertical, cylindrical tank to enhance separation. More particularly, tank has a helical guide on its inner surface to create a rotational flow. The rotational flow forces the lighter component, such as oil and gas droplets, towards an inner concentric cylindrical wall where they coalesce and rise to the surface of the liquid, whereas the heavier components move radially outward and downward. Water is discharged through a water outlet in the lower part of the tank.

EP 1 779 911 A1, EP 2 263 768 A1 and EP 2 442 881 B1 describe different varieties of a vertical cylindrical tank in which separation is enhanced by setting up at least one vortex. These varieties have a vortex breaker in the form of a disc near the water outlet in the lower part of the tank. Further needed is artificial preheating of the fluid and packing devices for obtaining maximum surface area for release of oil.

WO9965588 describes a separator tank for removing water from oil, in which process gas is added to the oil before the mixture is introduced at the bottom of a first section. Pressures are adjusted such that the gas forms bubbles rising through the fluid. The gas in the bubbles is rapidly heated by the ambient oil, so that its relative humidity decreases, and water vapour is pulled from the oil. The gas and water vapour are withdrawn from the top of the container, while the oil is removed from the bottom of a second section. The first and second sections of the container are separated by a partition wall, preferably in the form of a tube. Further needed is artificial preheating of the fluid and packing devices for obtaining maximum surface area.

WO2010080035 and WO2013109345A1 provide examples of a vertical, cylindrical separator tank in which a gas, e.g. N2, is added to the input fluid, and the mixture is entered into the tank through a central pipe within the tank. The central pipe comprises branches and tangentially oriented nozzles to set up a vortex. An outlet for hydrocarbons at the top, a helical guide on its inner surface, a vortex breaker and an outlet for clean water at the bottom are also provided. Guide plates are needed and there are no devices installed for arresting or reducing the swirling fluid action or unwanted fluid oscillation in the location where hydrocarbons and gas are leaving the water phase. This greatly reduces the efficiency at each stage.

EP 2 263 767 A1 describes a separator tank for separating oil and gas from water comprising a cylindrical vertical tank and inner conical segments where the mixture of liquid and gas are forced into a swirling upward motion along the outer conical walls and into the adjacent area at the cone top outlet. The separator does not provide adequate control of liquid flow in the hydrocarbon gas release zone, and the efficiency not satisfactory.

EP 1 779 911 A1 discloses a separator tank, and the inventor is the same as for present application. The separator tank of EP 1 779 911 A1 is compatible to the above EP 2 263 767 A1 containing a single conical frustum and the separator tank may be couple to one or more similar separator tanks for improving of the overall efficiency. The separator does not provide adequate control of liquid flow in the hydrocarbon gas release zone, and the efficiency not satisfactory.

The separators above may comprise several stages, such that the water output from one stage is the fluid input to the next stage below. Two to four stages are common, and each stage typically requires process gas. The pressure may be equal in all stages. However, it may be desirable to limit the pressure drop in each stage or tank segment to achieve a relatively slow flow within the segment, thereby increasing the amount of oil adhering to the bubbles within the segment, and hence the efficiency of the segment. A limited pressure drop at each stage may require additional stages to arrive at the desired output pressure. Further, marginal control of the liquid motion in the oil—water—gas separation zone may further reduce the efficiency by preventing optimum release of oil and gas which may require additional stages for approved cleaning. Gas—liquid mixers may also constitute a significant part in enhancing the overall efficiency of the process.

WO2017/164747, which belongs to the current proprietor, solves the problems associated with the above prior art by a separation apparatus having a tank segment with a truncated conical shaped tank segment (frustum) located inside the tank segment comprising a pipe spread, securing tangentially distribution of the fluid along the inner wall of the conical tank segment towards the upper part of the conical tank segment. Ring mounted spaced guide vanes are arranged at the upper part of the conical tank segment, arresting the swirling motion of the fluid and combining the remaining motion into axial and radial motion into the space between the vanes. A hydrocarbon outlet is arranged at a tank cap at the upper part of the tank wall, a pipe for scale and debris removal is connected to the lower part of the cone segment, and a water outlet is coupled at a bottom end of the tank segment. This separator has proven to have a very good performance.

U.S. Pat. No. 5,030,255 describes an apparatus for the gravitational separation of a hydrocarbon fluid comprised primarily of crude oil, water and varying amounts of gas. A separator tank is provided into which a stream of hydrocarbon fluid is introduced, and from which tank, discrete flows of crude oil, water and gas respectively are removed.

U.S. Pat. No. 4,416,789 describes ab apparatus and a plant for separating immiscible liquids. The apparatus includes a cylindrical tank, wherein there are provided a separation chamber, a heavy liquid phase collecting chamber, and a light liquid phase collecting chamber, said chambers being separated by a partition in the shape of a funnel opening at its top in the collecting chamber and by radial partitions which separates the two collecting chambers.

None of the above separators can easily be retrofitted into an existing separator vessel, such as a gravity separator vessel.

### SUMMARY OF INVENTION

Existing separators, especially gravity separators comprise a relatively large vessel. The efficiency of the gravity separator is however relatively low when the large volume is taken into account. It is therefore a desire to improve the efficiency of the separator. This can be done by placing an insert into the vessel, such as the insert described in the above-mentioned WO2017/164747 or the insert in the co-pending NO20190982, filed 14. Aug. 2019, which are incorporated herein by reference.

However, to be able to place such an insert into the vessel, a large opening has to be made in the vessel so that the insert can be brought through this opening. After the insert has been placed and secured inside the vessel, the opening has to be closed by welding the cut-away portion of the vessel. This is a very laborious operation, it may create a weakness in the wall of the vessel and it will be very difficult to maintain the insert when it has been arranged inside the vessel.

The object of the present invention is to provide a separator apparatus with an insert that can be more easily retrofitted into an existing separator vessel, such as a gravity separator vessel. This is achieved by a separation apparatus for separating hydrocarbons and water, comprising a vessel and an insert within said vessel, said insert comprising a bottom, a generally conical wall that has a narrowing diameter from the bottom and a quiescer at the top of the wall, said bottom, wall and quiescer enclosing a separation chamber, said insert further comprising an inlet pipe for an untreated mixture of water and hydrocarbons coupled to a spreader arrangement arranged inside said separation chamber immediately above said bottom, said spreader arrangement directing an inflow of fluids through the inlet pipe in a tangential direction within said separation chamber, setting the fluids into a tangential laminar swirl, wherein said vessel has at least one manhole through which a person can get access to the inside of said vessel, and said insert bottom, wall and quiescer are assembled by a plurality of generally wedge shaped segments, said segments having a size that allows the segments to be brought one by one through the manhole

The separator insert of the present invention works in general according to the same principles as the above-mentioned WO 2017/164747 and NO 20190982.

### BRIEF DESCRIPTION OF DRAWINGS

The invention will now be explained in further detail, referring to exemplary embodiments shown in the accompanying drawings, in which: FIGS. 1-4 show a gravity separator vessel with two inserts according to the present invention in partially transparent views, where:

FIG. 1 shows the vessel in an isometric view,

FIG. 2 shows the vessel in a side elevation view,

FIG. 3 shows the vessel in a planar top view, and

FIG. 4 shows the vessel in end elevation view.

FIGS. 5-8 show an insert according to the invention in various views, where:

FIG. 5 shows the insert in isometric view,

FIG. 6 shows the insert in cross-sectional elevation view,

FIG. 7 shows the insert in a top planar view, and

FIG. 8 shows a top cross-sectional view.

FIG. 9 shows a partially assembled insert in a first embodiment, and

FIG. 10 shows a partially assembled insert in a second embodiment.

### DETAILED DESCRIPTION OF THE INVENTION

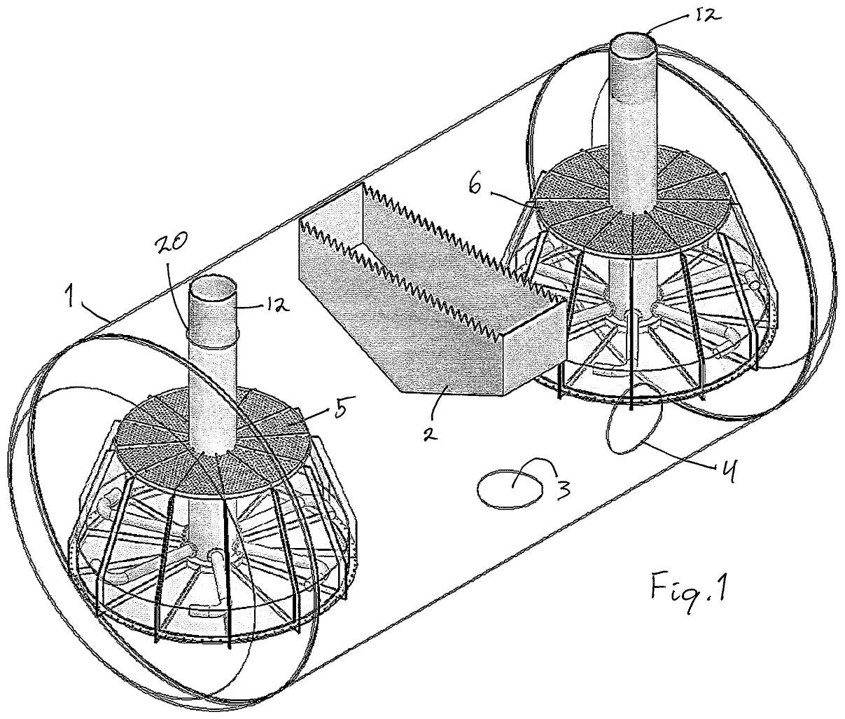

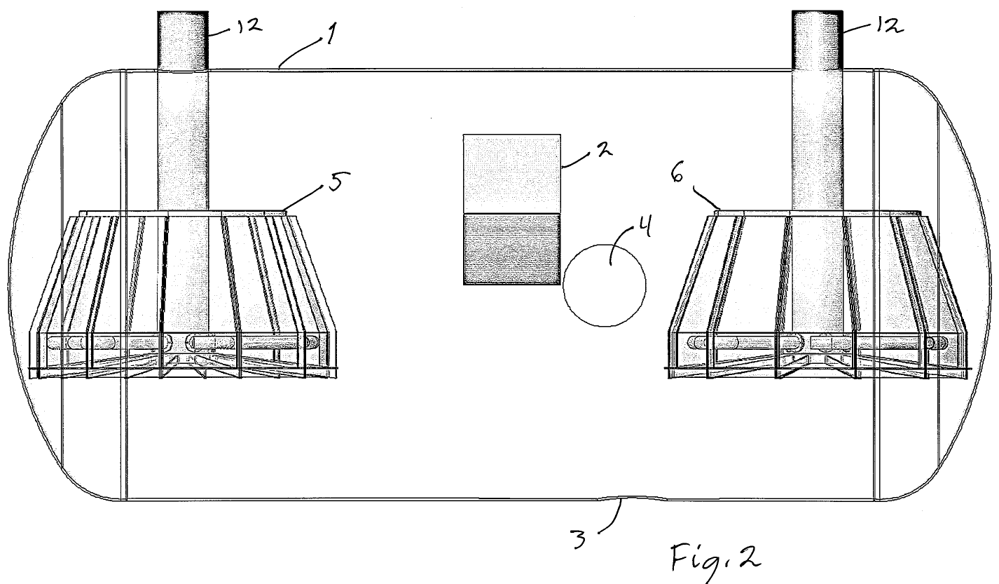

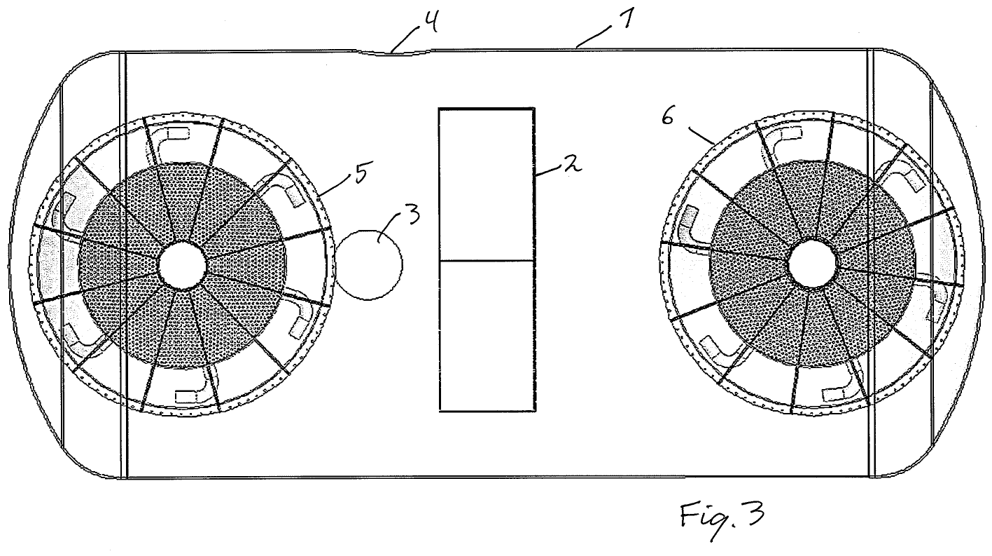

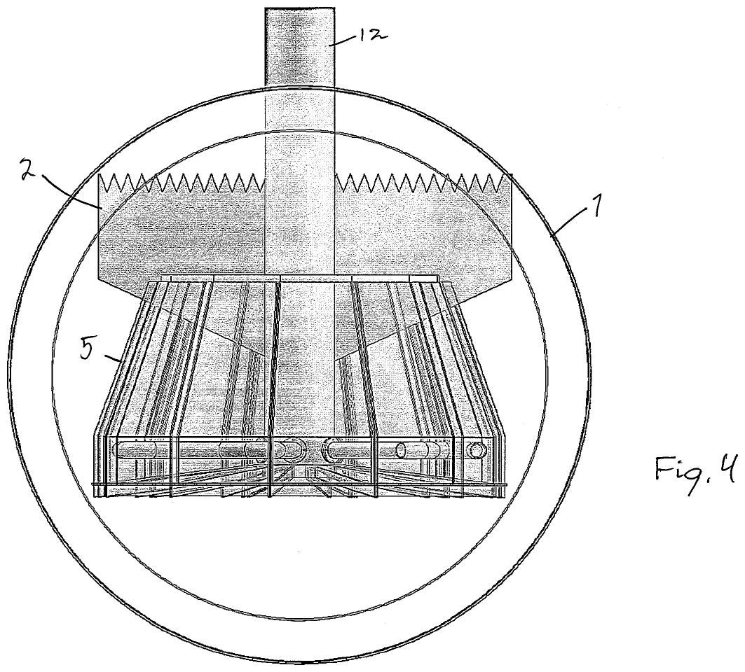

FIG. 1 shows a gravity separator vessel 1. The vessel is generally cylindrical. It has an inlet tube for well fluid and outlet tubes for water and oil and possibly gas. These are not shown in FIGS. 1-4. In the vessel, water and oil will separate due to gravity. In the vessel 1 a light liquid bucket 2 is arranged at a level which allows the oil to flow into the bucket 2.

The vessel has manholes 3, 4 for inspection of the interior of the vessel 1. These manholes 3, 4 are large enough for a person to crawl through.

FIGS. 1-4 shows two inserts 5, 6 that have been arranged within the vessel. The inserts 5, 6 are according to the invention and will be explained in detail below.

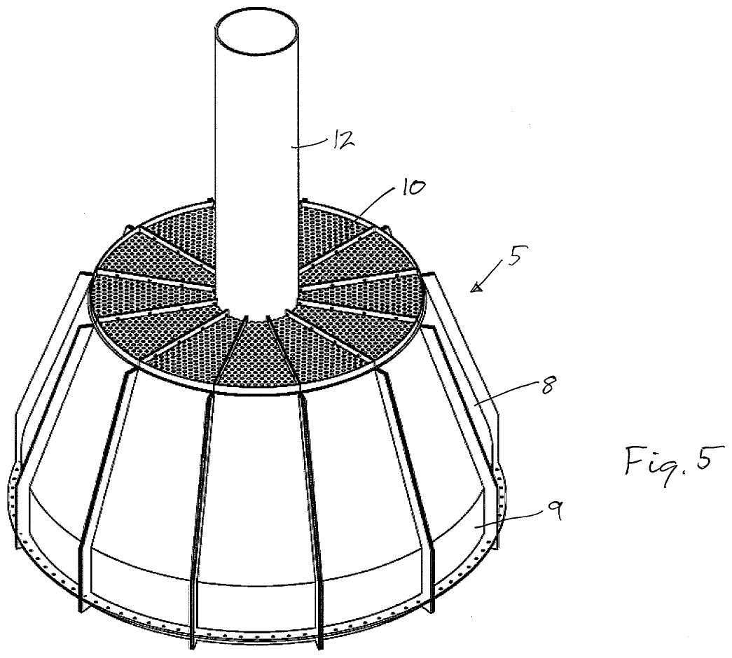

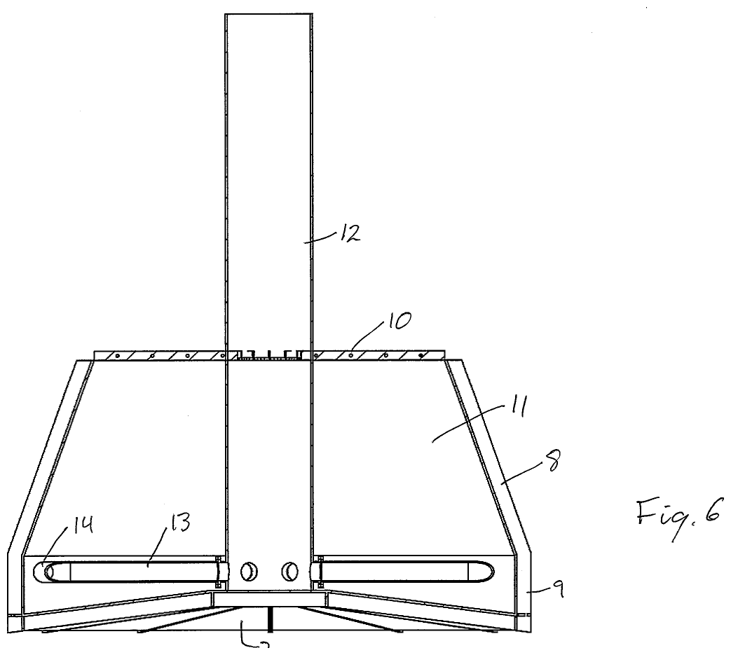

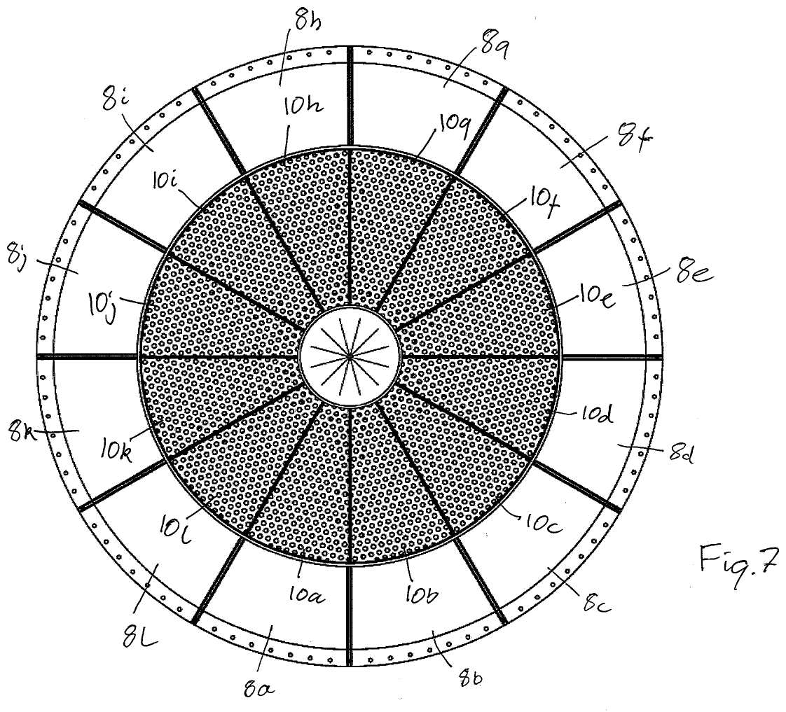

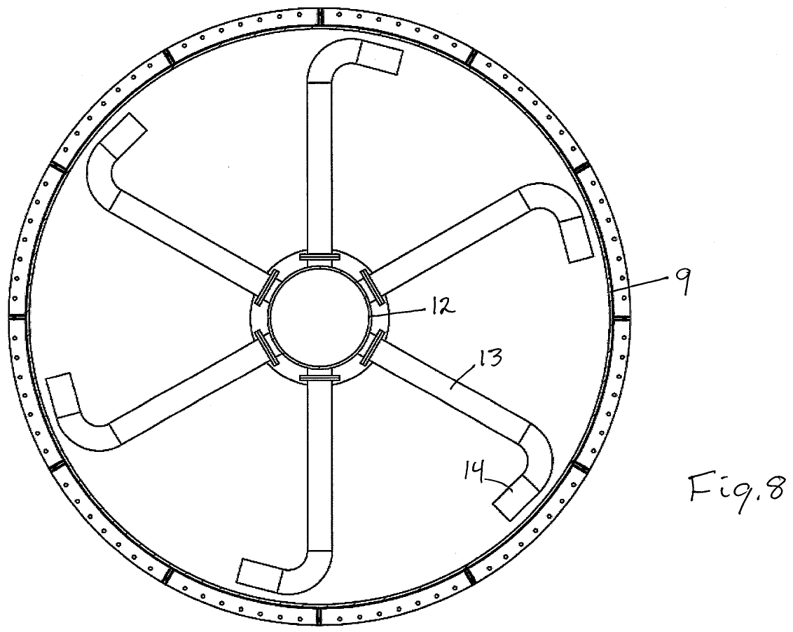

FIGS. 5-8 shows one insert 5 of the invention. The insert 5 comprises a bottom 7 (best shown in FIG. 6). The bottom has a slightly conical or convex shape with its lowest point along the perimeter of the bottom 7. The bottom is made up of a plurality of wedge-shaped segments 7a-7l (in the present case twelve segments), which are assembled to form a circular bottom.

The insert also has a wall 8, which joins the bottom 7 at the perimeter thereof. The wall 8 is generally conical, but may, as shown have a small cylindrical part 9 close to the bottom 7. The wall 8 is also made up of wedge-shaped segments 8a-8l (twelve in the shown embodiment).

At the top of the wall 8 a quiescer in the form of a grating 10 is attached. The grating 10 is also made up of wedge-shaped segments 10a-10l (twelve in the present case) that assembled form a circle.

The bottom 7, wall 8 and grating 10 enclose a separation chamber 11.

An inlet pipe 12 extends through the middle of the separation chamber 11 to the bottom 8 and is preferably attached to the apex of the bottom 8. The upper end of the pipe 12 extends out through the wall of the vessel 1. From the inlet pipe 12 a plurality of spreader arms 13 extend radially towards the wall 8. The spreader arms 13 have an outer portion 14 that extends in a tangential direction along the wall 8.

At the inside of the upper part of the wall 8 vertical vanes are arranged (not shown in the drawings).

The function of the separator insert is described in detail in NO 20190982 and will therefore only be given briefly here:

Well fluids mixed with gas are flowing through the pipe 12 to the spreader arms 13. Die to the tangential direction of the outlet from the spreader arms 13, the well fluid will be set into a swirling motion. The swirling motion will increase as the fluids are forced upward within the conical chamber 11. Particles in the fluids will be flung outwards and fall towards the bottom 7 along the wall 8 and collect at the perimeter of the bottom 7. Water in the swirling fluids will tend to collect into larger droplets, and as the flow exits the chamber 11 at the grating 10, the water will flow downwards on the outside of the insert 5 while the lighter oil and gas will collect above the insert 5.

The vanes (not shown) will slow down the swirl before it exits the insert 5, and the grating 10 at the top of the insert 5 will force the flow into an outwardly directed radial laminar flow.

Consequently, when the fluids exit the chamber 11 the water will already have been separated to a large extend from the oil and gas. The vessel 1 outside of the insert 5 will function as a gravitational separator and allow the fluids to further separate due to gravity. Hence the retention time of the fluids in the vessel can be greatly reduced compared to a conventional gravity separator.

It is convenient if the number of wedge-shaped segments of the bottom 7, wall 8 and grating 10 is equal, but it is also feasible to have a different number of segments for the bottom, wall and grating.

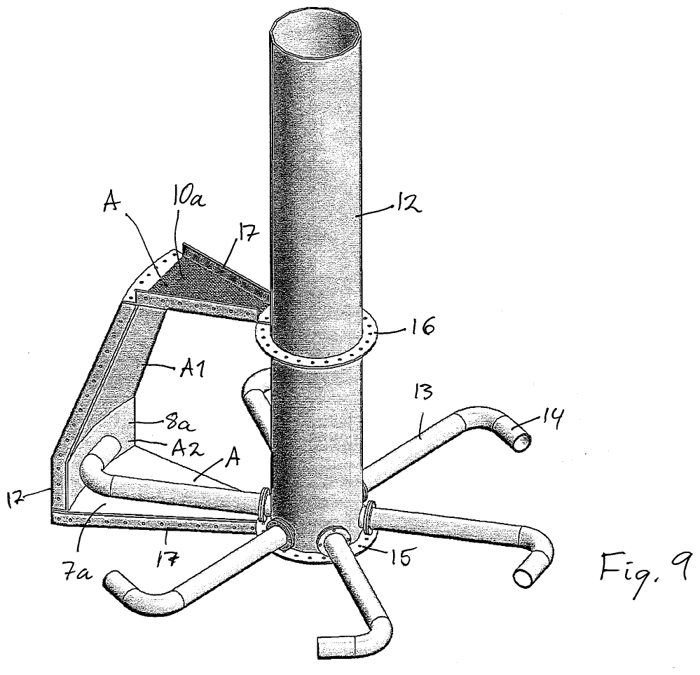

FIG. 9 shows a partially assembled insert. In this case the inlet pipe 12 enters the vessel 1 through the top thereof. The pipe 12 is equipped with a first bolt ring 15 and a second bolt ring 16. The bolt rings 15, 16 are preferably welded to the outside of the pipe 12. The first bolts ring 15 serves to support the bottom segments 7a-7l and the second bolt ring 16 serves to support the grating segments 10a-10l. In FIG. 9 one segment for each of the bottom 7, wall 8 and grating 10 has been mounted. These are denoted 7a, 8a and 10a.

Each of the segments 7a, 8a and 10a comprises a main portion A. For the bottom segment 7a and the grating segment 8a, this portion is generally planar, but for the wall segment 8a, the main portion is divided into a conus section A1 (i.e. a part of the resulting conical wall 8, and a cylinder section A2.

At right angle to the main portions are formed webs 17. These webs 17 are adapted to be mated with corresponding webs of adjoining segments. When the webs 17 of two adjoining segments are mated, a sealing is placed between the two webs. This can be a rubber seal, a polyurethane seal or similar sealing material that will endure the temperature and chemical impacts by the fluids in the separator.

With the seal in place, the webs are fixedly attached to one-another by bolts inserted through the webs.

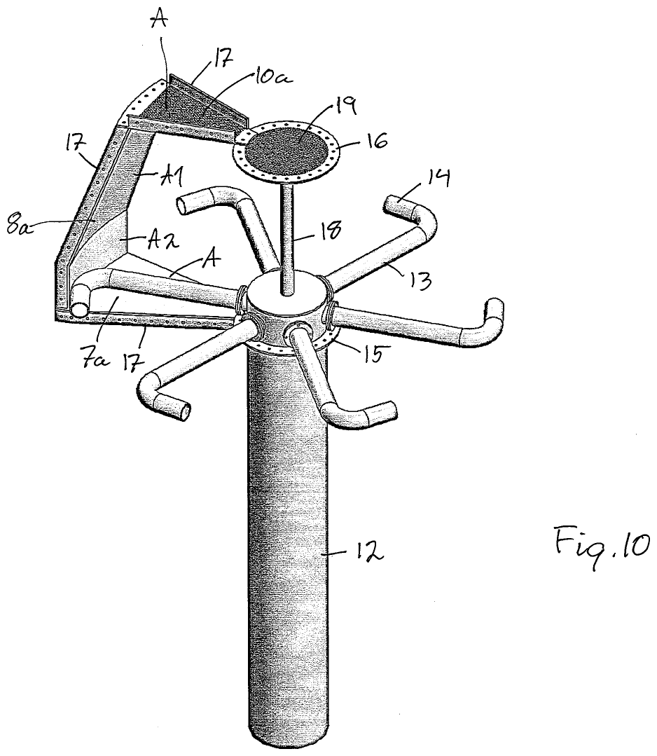

While FIG. 9 shows an insert where the inlet pipe 12 extends through the upper part of the vessel 1, FIG. 10 shows an embodiment with the inlet pipe 12 extending through the lower part of the vessel 1. This embodiment deviates from the embodiment of FIG. 9 by not having a second bolt ring 16 placed around the pipe 12. Instead the second bolt ring is placed at the end of a rod 18, that extends upwards from a closed end of the pipe 12. A grating 19 is arranged within the bolt ring 16. This grating 19 is of the same type as the grating 10. The two bolt rings 15, 16 are held at the same distance as the bolt rings 15, 16 of FIG. 9.

The installation of the insert may be done in a varying sequence depending on the space available within the vessel. Now will be explained a few alternative sequences.

First an opening 20 (see FIG. 1) for the inlet pipe 12 is made either at the top or the bottom of the vessel, depending on which direction the inlet is planned to be entering the vessel. The chosen direction depends on the space available above and below the vessel and where the well flow ducts are in relation to the vessel.

The pipe 12 is strong enough to carry the weight of the insert. Hence, the pipe 12 will be fixedly attached to the vessel wall. This may be done by welding or by attaching a collar to the vessel and around the pipe 12 at the opening 20.

The pipe may be brought through one of the manholes 3, 4 and inserted through the opening 20 from the inside of the vessel 1. Next the pipe 12 is positioned at a predetermined distance from the bottom of the vessel 1, which provides the workers sufficient space for performing the assembly of the insert.

When the pipe 12 has been positioned and fixedly attached to the vessel 1, the assembly of the segments forming the bottom 7, wall 8 and grating 10 can commence. The sequence of this assembly depends on the space available and the size of the insert.

In one sequence, the segments 7a-7l of the bottom 7 are first assembled by bolting the segments one by one to the first bolt ring 15 and to the adjoining segments. Then the spreader arms 13 are attached to the pipe 12 via flange connections. Then the wall segments 8a-8l are attached by bolts to the perimeter of the bottom 7 and to the adjoining wall segments. Finally, the grating segments 10a-10l are attached to the second bolt ring 16, to the top of the wall 8 and to the adjoining grating segments.

However, the assembly may also be done by attaching one bottom segment 7a, one wall segment 8a and one grating segment 10a to each other and then attach the combined structure to the bolt rings 15, 16. FIGS. 9 and 10 show the situation when the first combined structure has been attached. In this case, the spreader arms 13 will have to be attached to the pipe 12 either before the first segments 7a, 8a, 10a are attached, or at least before the last segments 7l, 8l, 10l are attached.

The bolt rings 15, 16 preferably have threaded holes, which enables the bolts to be screwed in from the outside of the insert without the need for a nut on the inside. The webs may be bolted together by bolts and nuts, as these are readily accessible from the outside of the insert.

When all the segments of the bottom 7, wall 8 and grating 10 have been assembled and are supported by the pipe 12, struts (not shown) are attached to the insert, at separate brackets (not shown) or a web 17, and already present features inside the vessel 1, such as the liquid bucket 2, partition walls or similar. These struts serve to stabilize the insert and prevent it from oscillating due to the swirling fluids. The positioning and length of the struts depend on the construction of the individual vessel 1.

Especially in larger vessels, the inlet pipe may also be fed through the vessel wall from the side or through the end caps, and the inlet pipe may have a bend that turns the direction of the pipe into the vertical. In that case the pipe has to be supported by brackets inside the vessel.

With the insert, or inserts properly installed inside the vessel, all that remain is to connect the inlet pipe to the well flow and gas mixer and close the manholes. The insert will separate the water and hydrocarbons efficiently. After this separation, the gravity separation inside the vessel but outside the inserts will work at a much higher efficiency than the original gravity separation without the inserts.

1. A separation apparatus for separating hydrocarbons and water, the separation apparatus comprising:
a vessel;
an insert within the vessel, the insert comprising a bottom,
a generally conical wall that has a narrowing diameter from the bottom and a quiescer at the top of the wall, the bottom, wall, and quiescer enclosing a separation chamber;
wherein the insert comprises an inlet pipe for an untreated mixture of water and hydrocarbons coupled to a spreader arrangement arranged inside the separation chamber immediately above the bottom, the spreader arrangement directing an inflow of fluids through the inlet pipe in a tangential direction within the separation chamber, setting the fluids into a tangential laminar swirl; and
wherein the vessel has at least one manhole through which a person can get access to the inside of the vessel, and the insert bottom, wall and quiescer are assembled by a plurality of generally wedge shaped segments, the segments having a size that allows the segments to be brought one by one through the manhole.

2. The separation apparatus of claim 1, wherein the inlet pipe is adapted to support the weight of the insert, the inlet pipe having a first and a second bolt ring attached thereto at mutual distance, the segments of the bottom being adapted to be bolted to the first bolt ring and the segments of the quiescer being adapted to be attached to the second bolt ring.

3. The separation apparatus of claim 2, wherein the inlet pipe extends from above the insert, through the quiescer to the spreader arrangement, and that both the two bolt rings are attached directly to the pipe.

4. The separation apparatus of claim 2, wherein the inlet pipe extends from below the insert, through the bottom, and that a first bolt ring is attached directly to the pipe and a second bolt ring is attached to a rod that in turn is attached to an end of the inlet pipe.

5. The separation apparatus of claim 1, wherein each segment has a web part at the edges that are to be attached to adjoining segments, the web part extending at right angle to a main plane of the segment, the web part 17 facing away from the separation chamber, web parts of adjoining segments being adapted to be connected by bolts.

6. The separation apparatus of claim 1, wherein the quiescer segments comprises a grating along their main plane.

7. The separation apparatus of claim 1, wherein the bottom, the wall and the quiescer have the same number of segments.

8. The separation apparatus of claim 1, wherein the segments constituting the bottom, wall and quiescer, respectively, are identical.

9. The separation apparatus of claim 1, wherein the vessel is a gravity separator and that the fluids exiting from the insert through the quiescer are further separated by gravity separation in the vessel outside of the insert.
